(19) United States
(12) Patent Application Publication
(10) Pub. No.: US 2022/0333357 A1
(43) Pub. Date: Oct. 20, 2022

(54) WORK MACHINE PERIPHERY MONITORING SYSTEM, WORK MACHINE, AND WORK MACHINE PERIPHERY MONITORING METHOD

(71) Applicant: Komatsu Ltd., Tokyo (JP)

(72) Inventors: Taro Eguchi, Tokyo (JP); Koichi Nakazawa, Tokyo (JP)

(73) Assignee: Komatsu Ltd., Tokyo (JP)

(21) Appl. No.: 17/762,845

(22) PCT Filed: Oct. 19, 2020
(86) PCT No.: PCT/JP2020/039241

§ 371 Date: Mar. 23, 2022

(30) Foreign Application Priority Data
Oct. 18, 2019 (JP) 2019-191213

(51) Int. Cl. E02F 9/26

(52) U.S. Cl. CPC E02F 9/262

(57) ABSTRACT

A work machine periphery monitoring system includes a display control unit that causes a display unit to display an image indicating a periphery of a work machine and a guide line arranged in at least a part of the periphery of the work machine in the image. The display control unit switches a display state of the guide line between a valid state in which an alarm is output when an object is present around the work machine and an invalid state in which no alarm is output.

### FIELD

The present disclosure relates to a work machine periphery monitoring system, a work machine, and a work machine periphery monitoring method.

### BACKGROUND

In a technical field related to a work machine, a work machine equipped with a periphery monitoring device as disclosed in Patent Literature 1 is known. In Patent Literature 1, a periphery monitor is disposed in a cab of the work machine. A display unit of the periphery monitor displays a bird's eye image around the work machine and a guide line. The guide line indicates an area in which an alarm is output when an object is present. The alarm is output when the object is present in the area inside the guide line.

### CITATION LIST

### Patent Literature

Patent Literature 1: WO 2016/159012 A

### SUMMARY

### Technical Problem

In a periphery monitoring device, it is assumed that a valid state in which an alarm is output when an object is present around a work machine and an invalid state in which no alarm is output are switched. There is a possibility that a plurality of persons boards the work machine. For example, a first driver may board, a second driver different from the first driver may board, or a maintenance person may board. When a first passenger switches the periphery monitoring device to the valid state or the invalid state, it is preferable that a second passenger who gets on the work machine next can easily recognize whether the periphery monitoring device is in the valid state or the invalid state.

### Solution to Problem

According to an aspect of the present invention, a work machine periphery monitoring system comprises: a display control unit that causes a display unit to display an image indicating a periphery of a work machine, and a guide line arranged in at least a part of the periphery of the work machine in the image, wherein the display control unit performs switching of a display state of the guide line between a valid state in which an alarm is output when an object is present around the work machine and an invalid state in which the alarm is not output.

### Advantageous Effects of Invention

According to the present disclosure, it is possible to provide an appropriate guide line to a driver in each of a valid state in which an alarm is output and an invalid state in which no alarm is output.

### BRIEF DESCRIPTION OF DRAWINGS

FIG. 1 is a perspective view illustrating a work machine according to an embodiment.

FIG. 2 illustrates a cab of the work machine according to the embodiment.

FIG. 3 is a schematic view illustrating an upper swinging platform according to the embodiment.

FIG. 4 is a schematic view illustrating an alarm range according to the embodiment.

FIG. 5 is a diagram illustrating a periphery monitor according to the embodiment.

FIG. 6 is a functional block diagram illustrating a periphery monitoring device according to the embodiment.

FIG. 7 is a schematic view illustrating a bird's eye image generation method according to the embodiment.

FIG. 8 is a flowchart illustrating a periphery monitoring method according to the embodiment.

FIG. 9 illustrates a display example of a display unit according to the embodiment.

FIG. 10 illustrates a display example of the display unit according to the embodiment.

FIG. 11 is a block diagram illustrating a computer system according to the embodiment.

### DESCRIPTION OF EMBODIMENTS

Hereinafter, embodiments according to the present disclosure will be described with reference to the drawings. However, the present disclosure is not limited thereto. Components of the embodiments described below can be appropriately combined. Further, some components may not be used.

[Work Machine]

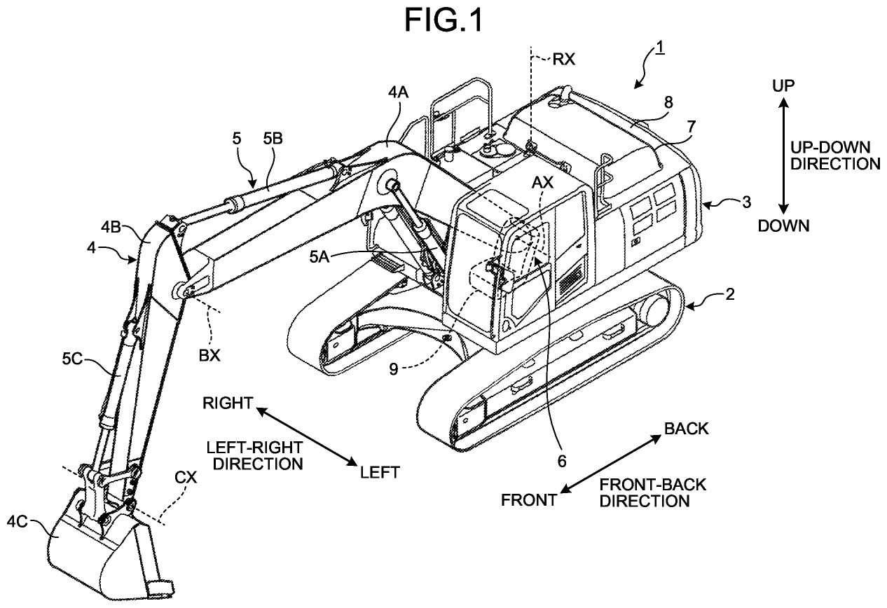

FIG. 1 is a perspective view illustrating a work machine 1 according to an embodiment. In the embodiment, it is assumed that the work machine 1 is an excavator. In the following description, the work machine 1 is referred to as an excavator 1 as appropriate.

As illustrated in FIG. 1, the excavator 1 includes a lower traveling body 2, an upper swinging platform 3 supported by the lower traveling body 2, working equipment 4 supported by the upper swinging platform 3, and a hydraulic cylinder 5 that drives the working equipment 4.

The lower traveling body 2 can travel while supporting the upper swinging platform 3. The lower traveling body 2 has a pair of crawlers. When the crawlers rotate, the lower traveling body 2 travels.

The upper swinging platform 3 is swingable about a swing axis RX while being supported by the lower traveling body 2. The upper swinging platform 3 is provided with a cab 6 on which a driver of the excavator 1 rides. A driver seat 9 on which the driver sits is provided in the cab 6.

The working equipment 4 includes a boom 4A connected to the upper swinging platform 3, an arm 4B connected to the boom 4A, and a bucket 4C connected to the arm 4B. The hydraulic cylinder 5 includes a boom cylinder 5A that drives the boom 4A, an arm cylinder 5B that drives the arm 4B, and a bucket cylinder 5C that drives the bucket 4C.

The boom 4A is supported by the upper swinging platform 3 so as to be rotatable about a boom rotation axis AX. The arm 4B is supported by the boom 4A so as to be rotatable about an arm rotation axis BX. The bucket 4C is supported by the arm 4B so as to be rotatable about a bucket rotation axis CX.

The boom rotation axis AX, the arm rotation axis BX, and the bucket rotation axis CX are parallel to each other. The boom rotation axis AX, the arm rotation axis BX, and the bucket rotation axis CX are orthogonal to an axis parallel to the swing axis RX. In the following description, a direction parallel to the swing axis RX will be referred to as an up-down direction, as appropriate, a direction parallel to the boom rotation axis AX, the arm rotation axis BX, and the bucket rotation axis CX will be referred to as a left-right direction, as appropriate, and a direction orthogonal to both the boom rotation axis AX, the arm rotation axis BX, and the bucket rotation axis CX, and the swing axis RX will be referred to as a front-back direction, as appropriate. A direction in which the working equipment 4 exists with respect to the driver seated on the driver seat 9 is front, and an opposite direction of the front is back. One of the left-right direction with respect to the driver seated on the driver seat 9 is a right direction, and an opposite direction of the right direction is a left direction. A direction away from a ground contact surface of the lower traveling body 2 is an up direction, and an opposite direction of the up direction is a down direction.

The upper swinging platform 3 includes a power container 7 and a counterweight 8. The power container 7 and the counterweight 8 are disposed at a back part of the upper swinging platform 3. The counterweight 8 is disposed behind the power container 7. The power container 7 houses an engine, a hydraulic pump, a radiator, and an oil cooler.

The cab 6 is disposed at a front part of the upper swinging platform 3. The cab 6 is disposed on a left side of the working equipment 4. The boom 4A of the working equipment 4 is disposed on a right side of the cab 6.

[Cab]

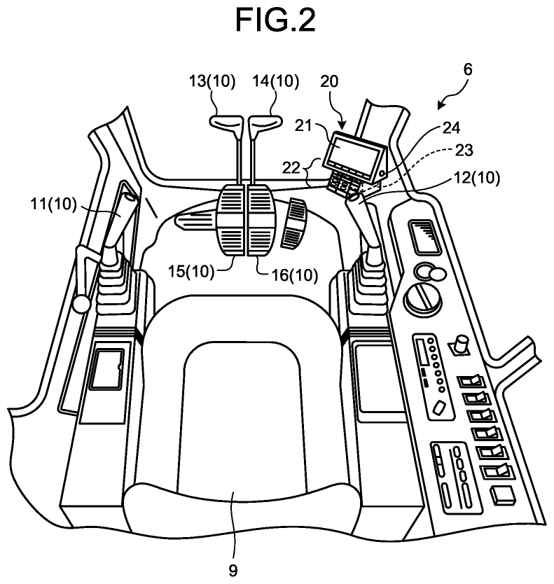

FIG. 2 illustrates the cab 6 of the excavator 1 according to the embodiment. As illustrated in FIG. 2, the driver seat 9 on which the driver of the excavator 1 is seated is provided in the cab 6.

The excavator 1 includes an operation unit 10 disposed in the cab 6. The operation unit 10 is operated for the operation of at least a part of the excavator 1. The operation unit 10 is operated by the driver seated on the driver seat 9. The operation of the excavator 1 includes at least one of an operation of the lower traveling body 2, an operation of the upper swinging platform 3, and an operation of the working equipment 4.

The operation unit 10 includes a left work lever 11 and a right work lever 12 operated for the operation of the upper swinging platform 3 and the working equipment 4, a left travel lever 13 and a right travel lever 14 operated for the operation of the lower traveling body 2, and a left foot pedal 15 and a right foot pedal 16.

The left work lever 11 is disposed on the left side of the driver seat 9. The right work lever 12 is disposed on the right side of the driver seat 9. When the left work lever 11 is operated in the front-back direction, the arm 4B performs a dumping operation or an excavating operation. When the left work lever 11 is operated in the left-right direction, the upper swinging platform 3 swings leftward or rightward. When the right work lever 12 is operated in the left-right direction, the bucket 4C performs an excavating operation or a dumping operation. When the right work lever 12 is operated in the front-back direction, the boom 4A is lowered or raised. Note that the upper swinging platform 3 may swing rightward or leftward when the left work lever 11 is operated in the front-back direction, and the arm 4B may perform the dumping operation or the excavating operation when the left work lever 11 is operated in the left-right direction.

The left travel lever 13 and the right travel lever 14 are disposed in front of the driver seat 9. The left travel lever 13 is disposed on the left side of the right travel lever 14. When the left travel lever 13 is operated in the front-back direction, the left crawler of the lower traveling body 2 moves forward or backward. When the right travel lever 14 is operated in the front-back direction, the right crawler of the lower traveling body 2 moves forward or backward.

The left foot pedal 15 and the right foot pedal 16 are disposed in front of the driver seat 9. The left foot pedal 15 is disposed on the left side of the right foot pedal 16. The left foot pedal 15 is interlocked with the left travel lever 13. The right foot pedal 16 is interlocked with the right travel lever 14. The lower traveling body 2 may be moved forward or backward by operating the left foot pedal 15 and the right foot pedal 16.

The excavator 1 includes a periphery monitor 20 disposed in the cab 6. The periphery monitor 20 is disposed on the right front side of the driver seat 9. The periphery monitor 20 includes a display unit 21, an operation unit 22, a control unit 23, and an alarm unit 24.

The display unit 21 displays prescribed display data. The display unit 21 includes a flat panel display such as a liquid crystal display (LCD) or an organic electroluminescence display (OELD).

The operation unit 22 includes a plurality of switches that is operated by the driver. The operation unit 22 is operated by the driver to output an operation command.

The control unit 23 includes a computer system. The control unit 23 performs prescribed arithmetic processing and image processing.

The alarm unit 24 outputs a buzzer.

[Camera]

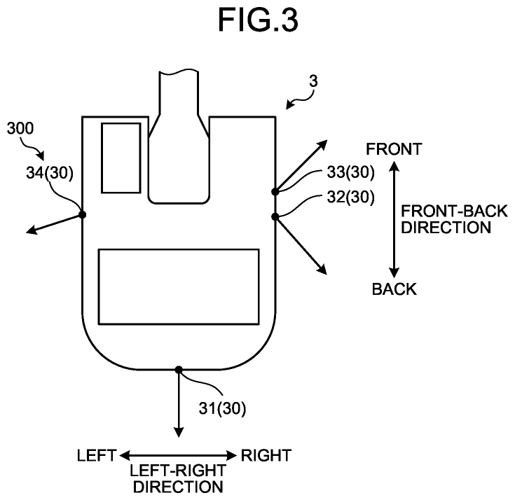

FIG. 3 is a schematic view illustrating the upper swinging platform 3 according to the embodiment. The excavator 1 includes a camera system 300 including a plurality of cameras 30. The plurality of cameras 30 is provided in the upper swinging platform 3. The cameras 30 acquire target images to be captured. As illustrated in FIG. 3, the camera 30 includes a back camera 31 provided at a back part of the upper swinging platform 3, a right back camera 32 and a right front camera 33 provided at a right part of the upper swinging platform 3, and a left back camera 34 provided at a left part of the upper swinging platform 3.

The back camera 31 captures an image of a back area of the upper swinging platform 3. The right back camera 32 captures an image of a right back area of the upper swinging platform 3. The right front camera 33 captures an image of a right front area of the upper swinging platform 3. The left back camera 34 captures an image of a left back area of the upper swinging platform 3. Each of the plurality of cameras 30 (31, 32, 33, and 34) includes an optical system and an image sensor. The image sensor includes a couple charged device (CCD) image sensor or a complementary metal oxide semiconductor (CMOS) image sensor.

Note that the left back camera 34 captures images in a range of the left side area and the left back area of the upper swinging platform 3, but may capture the image in either one of the areas. Similarly, the right back camera 32 captures images in a range of the right side area and the right back area of the upper swinging platform 3, but may capture the image in either one of the areas. Similarly, the right front camera 33 captures the image in a range of the right front area and the right side area of the upper swinging platform 3, but may capture the image in either one of the areas. Furthermore, the cameras 30 capture images in the left back side, the back side, the right back side, and the right front side of the upper swinging platform 3, but the present disclosure is not limited thereto in other embodiments. For example, the number of cameras 30 according to other embodiments may be different from the example illustrated in FIG. 3. In addition, a range of the left back, the back, the right back, and the right front of the upper swinging platform 3 may not be set as imaging ranges.

In the embodiment, the cameras 30 function as an object detection unit that detects an object OB around the excavator 1 in a non-contact manner. The cameras 30 have a detection range A in which the object OB can be detected. The detection range A includes a visual field range (imaging feasible range) of the camera 30. Image data acquired by the cameras 30 is subjected to image processing by the control unit 23. The control unit 23 can determine whether or not the object OB exists in the detection range A of the cameras 30 by performing image processing on the image data. Note that the object OB detected by the image processing may be an obstacle including a person and an object, may be only a person, or may be a moving object.

[Alarm Range]

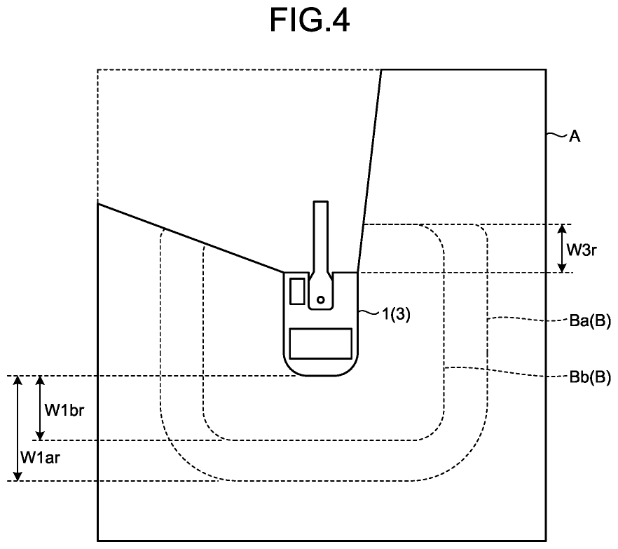

FIG. 4 is a schematic view illustrating an alarm range B according to the embodiment. As illustrated in FIG. 4, the alarm range B is set in the detection range A of the cameras 30. The alarm range B is smaller than the detection range A. The alarm range B is a range in which an alarm is required to be output when the object OB is present. When one of the cameras 30 detects the object OB present in the alarm range B, the buzzer is output from the alarm unit 24. In other embodiments, the alarm range B may be the same as or larger than the detection range A.

In the embodiment, the detection range A does not exist in the front and left front of the cab 6. The driver seated on the driver seat 9 can directly visually recognize the conditions in the front and left front of the cab 6. Therefore, the excavator 1 is not provided with the cameras 30 that acquire image data indicating conditions of the front and left front of the cab 6. As a result, the number of cameras 30 provided in the excavator 1 can be reduced. Note that the cameras 30 that acquire the image data indicating conditions of the front and left front of the cab 6 may be provided.

In the embodiment, the control unit 23 switches between a valid state in which the alarm is output due to the presence of the object OB around the excavator 1 and an invalid state in which no alarm is output. In the valid state, when the object OB is present in the alarm range B, the alarm is output. In the invalid state, the alarm is not output even when the object OB is present in the alarm range B.

The alarm refers to output information that is output when the object OB is detected. In the embodiment, the alarm is the buzzer output from the alarm unit 24 or a message or symbol displayed on the display unit 21. In addition, another example of the alarm is Patlite (registered trademark) provided in the excavator 1. The Patlite can draw attention of a person around the excavator 1. Still another example of the alarm is a warning lamp by a display lamp, an LED, or the like provided in the cab 6.

For example, in a case where the object OB present around the excavator 1 is the object OB necessary for work of the excavator 1, or in a case where the driver sufficiently recognizes conditions around the excavator 1, the driver may feel annoyed when the alarm is output. In other words, depending on an operation state of the excavator 1, the alarm output may not be essential. In order to suppress the output of an unnecessary alarm, the control unit 23 can switch to the invalid state in which no alarm is output.

The driver operates the operation unit 22 to switch between the valid state and the invalid state. An operation command generated by operating the operation unit 22 is output to the control unit 23. The control unit 23 then switches between the valid state and the invalid state according to the operation command. In a case where the driver desires to suppress output of an unnecessary alarm, the driver operates the operation unit 22 to set to the invalid state. In a case where the driver desires to output the alarm when the object OB is present around the excavator 1, the driver operates the operation unit 22 to set to the valid state.

In the valid state, when the object OB is present inside the alarm range B, the alarm is output. Even in the valid state, when the object OB is present outside the alarm range B, no alarm is output. When the alarm range B has the same size as the detection range A or is larger than the detection range A, the alarm may be output. In the invalid state, the alarm is not output even when the object OB is present inside the alarm range B.

The alarm range B is set to include the excavator 1. In the embodiment, the alarm range B includes a first alarm range Ba and a second alarm range Bb. The second alarm range Bb is set to include the excavator 1. The excavator 1 is disposed inside the second alarm range Bb. The second alarm range Bb is defined inside the first alarm range Ba. The second alarm range Bb is smaller than the first alarm range Ba.

In the embodiment, each of the first alarm range Ba and the second alarm range Bb has a substantially rectangular shape. A front end of the first alarm range Ba coincides with a front end of the second alarm range Bb. A back end of the first alarm range Ba is defined behind a back end of the second alarm range Bb. A left end of the first alarm range Ba is defined to the left of a left end of the second alarm range Bb. A right end of the first alarm range Ba is defined to the right of a right end of the second alarm range Bb.

In the valid state, when the object OB is present inside the first alarm range Ba and outside the second alarm range Bb, the alarm is output. In the valid state, when the object OB is present inside the second alarm range Bb, the alarm is output. Further, the operation of a vehicle body of the work machine 1 may be restricted. For example, before the work machine 1 travels or swings, a start lock that is prohibition control of traveling or swing may be applied. Still more, when the work machine 1 is traveling, the traveling of the lower traveling body 2 may be stopped or decelerated. Still more, during swinging, the swinging operation of the upper swinging platform 3 may be stopped or decelerated. Further, other operations of the vehicle body may be suppressed.

As illustrated in FIG. 4, a distance W1ar between the back end of the upper swinging platform 3 and the back end of the first alarm range Ba is longer than a distance W1br between the back end of the upper swinging platform 3 and the back end of the second alarm range Bb. A distance W3r between the front end of the upper swinging platform 3 and the front end of the first alarm range Ba (second alarm range Bb) is shorter than the distance W1br. As an example, the distance W1ar is about 4.5 [m], the distance W1br is about 2.5 [m], and the distance W3r is about 1.0 [m]. The driver of the excavator 1 can directly visually recognize the conditions in front of the upper swinging platform 3. Therefore, the distance W3r may be short.

[Periphery Monitor]

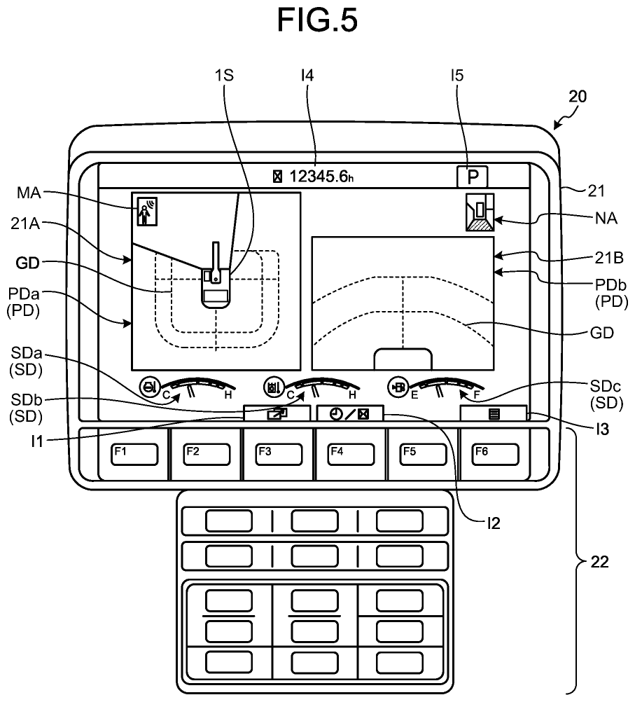

FIG. 5 illustrates the periphery monitor 20 according to the embodiment. As illustrated in FIG. 5, the periphery monitor 20 includes the display unit 21 and the operation unit 22.

The display unit 21 displays predetermined display data. The display data displayed on the display unit 21 includes periphery image data PD indicating conditions around the excavator 1, a guide line GD indicating a reference of one or both of the distance and the direction from the upper swinging platform 3, and condition image data SD indicating a state of the excavator 1.

The periphery image data PD includes one or both of a bird's eye image PDa and a single camera image PDb around the excavator 1.

The bird's eye image PDa refers to an image generated by changing and synthesizing a plurality of pieces of image data acquired by the plurality of cameras 30 to an upper viewpoint.

The single camera image PDb refers to an image of a partial periphery of the excavator 1 acquired by one of the plurality of cameras 30. The single camera image PDb includes at least one of a back single camera image indicating back conditions of the excavator 1 acquired by the back camera 31, a right back single camera image indicating right back conditions of the excavator 1 acquired by the right back camera 32, a right front single camera image indicating right front conditions of the excavator 1 acquired by the right front camera 33, and a left back single camera image indicating left back conditions of the excavator 1 acquired by the left back camera 34.

In the example illustrated in FIG. 5, the bird's eye image PDa is displayed in a first area 21A of a display screen of the display unit 21. The single camera image PDb is displayed in a second area 21B of the display screen of the display unit 21. The first area 21A and the second area 21B are set at the center of the display screen in the up-down direction of the display screen of the display unit 21. The first area 21A is set on the left side of the second area 21B.

As illustrated in FIG. 5, the display unit 21 displays a symbol image 1S indicating the excavator 1 together with the bird's eye image PDa. The symbol image 1S corresponds to an image of the excavator 1 viewed from above. The symbol image 1S clarifies the positional relationship between the excavator 1 and a periphery around the excavator 1.

In the example illustrated in FIG. 5, the single camera image PDb displayed in the second area 21B is the back single camera image indicating conditions at the back of the excavator 1 acquired by the back camera 31. Note that the single camera image PDb displayed in the second area 21B may be the right back single camera image, the right front single camera image, or the left back single camera image. Note that, in other embodiments, a camera image may be switched to the single camera image PDb in which the object OB is detected.

The guide line GD indicates a reference distance from the upper swinging platform 3. The guide line GD may indicate a reference distance and direction from the upper swinging platform 3. The guide line DG may indicate the distance and the direction from the swing axis RX of the upper swinging platform 3, or may indicate a distance and a direction from an outer edge of the upper swinging platform 3.

The guide line GD is arranged around the excavator 1 (symbol image 1S) in the bird's eye image PDa. The guide line GD has a linear shape.

In the example illustrated in FIG. 5, the guide line GD is displayed on the display unit 21 together with the single camera image PDb. Note that the guide line GD may not be displayed in the single camera image PDb.

Condition image data SD includes a water temperature gauge SDa indicating a temperature of cooling water for the engine, an oil temperature gauge SDb indicating a temperature of a hydraulic oil of hydraulic equipment, and a fuel level gauge SDc indicating a level of a remaining amount of fuel.

In addition, the display unit 21 displays a symbol MA on upper left of the bird's eye image PDa. The symbol MA indicates the valid state in which the alarm is output. In the valid state, the symbol MA is displayed. In the invalid state, the symbol MA is not displayed. In the symbol MA, a color of the symbol displayed may be changed according to an area where the object OB is detected. For example, when the object OB is detected inside the second alarm range Bb, the color of the symbol MA may be displayed in red, and when the object OB is detected inside the first alarm range Ba and outside the second alarm range Bb, the color of the symbol MA may be displayed in yellow.

In addition, the display unit 21 displays a symbol NA on upper right of the single camera image PDb. The symbol NA indicates a direction of the single camera image PDb displayed in the second area 21B with respect to the excavator 1. In the example illustrated in FIG. 5, the symbol NA has an identification area indicating that the single camera image PDb is the back single camera image captured by the back camera 31. The identification area may be hatched or may have a color different from the surrounding.

The operation unit 22 includes a plurality of function switches F1, F2, F3, F4, F5, and F6 disposed below the display screen of the display unit 21. A specific function is assigned to each of the function switches F1, F2, F3, F4, F5, and F6. A plurality of icons is displayed at a lower part of the display screen of the display unit 21. The icons are displayed immediately above the function switches F1, F2, F3, F4, F5, and F6. When the function switches F1, F2, F3, F4, F5, and F6 are operated by the driver, an operation signal of a specific function corresponding to the icon displayed immediately above is generated.

In the example illustrated in FIG. 5, a plurality of icons I1, I2, and I3 is displayed at the lower part of the display screen of the display unit 21. An icon I1 is displayed immediately above the function switch F3. An icon I2 is displayed immediately above the function switch F4. An icon I3 is displayed immediately above the function switch F6.

In addition, in the example illustrated in FIG. 5, a plurality of icons 14 and I5 is displayed on the upper part of the display screen of the display unit 21. The icon I4 indicates a service meter value. The icon I5 indicates a set work mode.

At least one switch of the operation unit 22 is operated to switch between the valid state and the invalid state of a function of detecting an object.

[Periphery Monitoring Device]

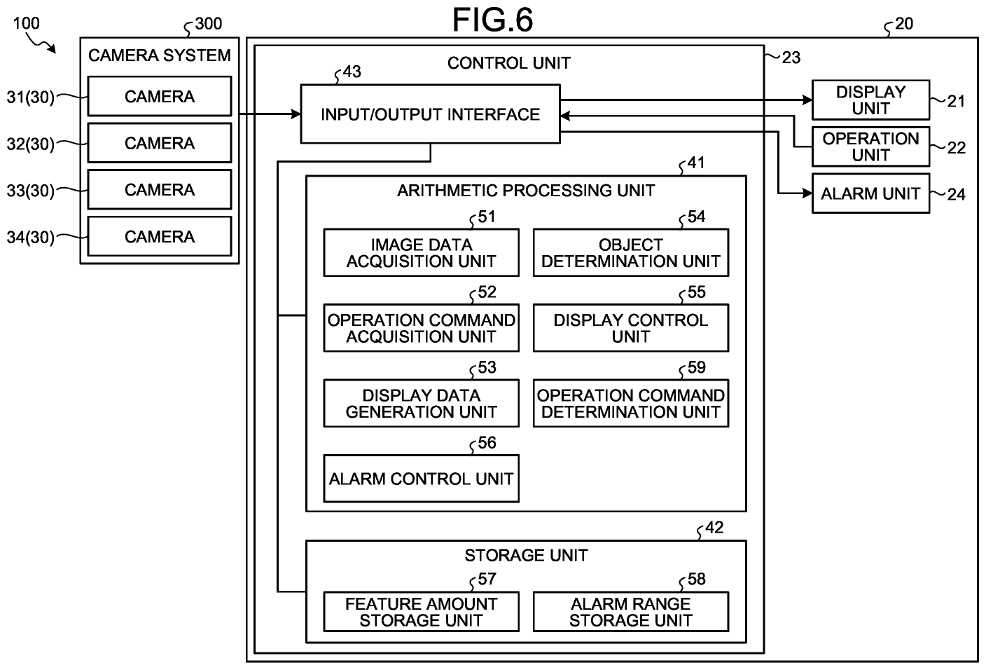

FIG. 6 is a functional block diagram illustrating a periphery monitoring device 100 according to the embodiment. The excavator 1 is equipped with the periphery monitoring device 100. The periphery monitoring device 100 monitors around the excavator 1.

The periphery monitoring device 100 includes a periphery monitor 20 and a camera system 300. The periphery monitor 20 includes the display unit 21, the operation unit 22, the control unit 23, and the alarm unit 24. The camera system 300 includes the plurality of cameras 30 (31, 32, 33, and 34).

The control unit 23 includes a computer system. The control unit 23 includes an arithmetic processing unit 41 including a processor such as a central processing unit (CPU), a storage unit 42 including a volatile memory such as a random access memory (RAM) and a nonvolatile memory such as a read only memory (ROM), and an input/output interface 43.

The input/output interface 43 is connected to each of the camera system 300, the display unit 21, the operation unit 22, and the alarm unit 24.

The arithmetic processing unit 41 includes an image data acquisition unit 51, an operation command acquisition unit 52, a display data generation unit 53, an object determination unit 54, a display control unit 55, an operation command determination unit 59, and an alarm control unit 56.

The storage unit 42 includes a feature amount storage unit 57 and an alarm range storage unit 58.

The image data acquisition unit 51 acquires image data from the camera system 300. The image data acquisition unit 51 acquires image data indicating the conditions at the back of the excavator 1 from the back camera 31. The image data acquisition unit 51 acquires image data indicating the conditions at the right back of the excavator 1 from the right back camera 32. The image data acquisition unit 51 acquires image data indicating the conditions at the right front of the excavator 1 from the right front camera 33. The image data acquisition unit 51 acquires image data indicating the conditions at the left back of the excavator 1 from the left back camera 34.

The operation command acquisition unit 52 acquires the operation command output from the operation unit 22. The operation command includes an operation command for switching from the valid state to the invalid state and an operation command for switching from the invalid state to the valid state. The valid state and the invalid state are switched according to the operation command.

The display data generation unit 53 generates periphery display data PD indicating the conditions around the excavator 1 based on the image data acquired by the image data acquisition unit 51. The periphery display data PD includes the bird's eye image PDa around the excavator 1 and the single camera image PDb around the excavator 1.

The display data generation unit 53 generates the bird's eye image PDa around the excavator 1 based on the image data acquired by each of the plurality of cameras 30. The display data generation unit 53 generates the single camera image PDb based on the image data acquired by one of the plurality of cameras 30.

The object determination unit 54 determines whether or not the object OB is present around the excavator 1 based on the image data acquired by the image data acquisition unit 51. The object determination unit 54 can determine the presence or absence of the object OB by applying image processing to the image data acquired by the image data acquisition unit 51. The image processing includes a process of extracting a feature amount of the object OB from the image data. The storage unit 42 includes the feature amount storage unit 57 that stores the feature amount of the object OB. The feature amount includes a feature amount of a person and a feature amount of the object OB present at a work site collected at the work site. The object determination unit 54 collates the feature amount extracted from the image data with the feature amount stored in the feature amount storage unit 57 to determine whether or not the object OB is present around the excavator 1.

The display control unit 55 causes the display unit 21 to display prescribed display data. The display data includes the periphery image data PD, the guide line GD, and the condition image data SD. The periphery image data PD includes the bird's eye image PDa and the single camera image PDb. In the embodiment, the display control unit 55 causes the display unit 21 to display at least the bird's eye image PDa around the excavator 1.

The guide line GD indicates a reference distance from the upper swinging platform 3. The guide line GD may indicate a reference distance and direction from the upper swinging platform 3. The guide line GD is displayed on the display unit 21 so as to be arranged in at least a part of the periphery of the excavator 1 (symbol image 1S) in the bird's eye image PDa. In addition to the bird's eye image PDa, the display control unit 55 caused to display the guide line GD in at least a part of the periphery of the excavator 1 in the bird's eye image PDa displayed on the display screen of the display unit 21.

The display control unit 55 switches a display state of the guide line GD between the valid state in which the alarm is output due to the presence of the object OB around the excavator 1 and the invalid state in which no alarm is output.

Switching the display state of the guide line GD includes switching the distance between the excavator 1 (symbol image 1S) and the guide line GD on the display screen of the display unit 21.

Switching the display state of the guide line GD includes switching a shape of the guide line GD on the display screen of the display unit 21.

In the valid state, the display control unit 55 causes the display unit 21 to display the guide line GD so as to define the alarm range B. The alarm range data indicating the alarm range B is stored in the alarm range storage unit 58. The alarm range data includes a distance between the outer edge of the upper swinging platform 3 and an edge of the alarm range B and an outer shape of the alarm range B. The display control unit 55 causes the display unit 21 to display the guide line GD so as to define the alarm range B on the display screen of the display unit 21 based on the alarm range data stored in the alarm range storage unit 58. The display control unit 55 causes to display the guide line GD based on the outer shape of the alarm range B. Note that the display control unit 55 may change the shape from the outer shape of the alarm range B and cause to display the guide line GD.

The operation command determination unit 59 determines whether the operation command acquired by the operation command acquisition unit 52 is an operation command for setting the valid state or an operation command for setting the invalid state.

The alarm control unit 56 outputs at least one of an operation command for outputting the alarm and a stop command for not outputting the alarm. When the operation command is output, the alarm is output. For example, in a case where the alarm is the buzzer of the alarm unit 24, the buzzer of the alarm unit 24 is output when the operation command is output. When the stop command is output, the buzzer is not output from the alarm unit 24. For example, in a case where the alarm is a message or a symbol displayed on the display unit 21, the message or the symbol is output to the display unit 21 by the control of the display control unit 55 when the operation command is output. When the stop command is output, the message or the symbol is not output to the display unit 21. The operation command determination unit 59 determines whether the operation command acquired by the operation command acquisition unit 52 is an operation command for setting the valid state or an operation command for setting the invalid state. The alarm control unit 56 switches between the valid state in which the alarm is output due to the presence of the object OB around the excavator 1 and the invalid state in which no alarm is output based on determination of the operation command determination unit 59.

[Bird's Eye Image Generation Method]

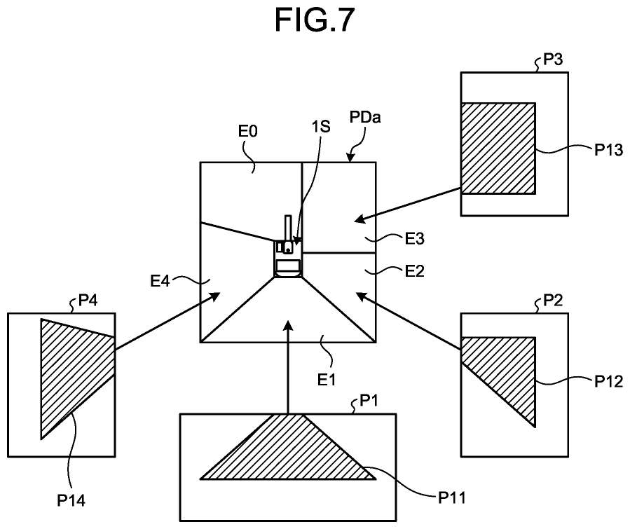

FIG. 7 is a schematic diagram illustrating a bird's eye image generation method according to the embodiment. As illustrated in FIG. 7, the display data generation unit 53 generates the bird's eye image PDa around the excavator 1 based on the image data acquired by the plurality of cameras 30 (31, 32, 33, and 34).

As illustrated in FIG. 7, the display data generation unit 53 converts image data P1, image data P2, image data P3, and image data P4 acquired by each of the back camera 31, the right back camera 32, the right front camera 33, and the left back camera 34 into converted image data P11, converted image data P12, converted image data P13, and converted image data P14 indicating an upper viewpoint image viewed from a virtual viewpoint above the excavator 1, respectively.

The display data generation unit 53 cuts out portions corresponding to frame regions E1, E2, E3, and E4 for displaying the bird's eye image PDa from the converted image data P11, P12, P13, and P14. The display data generation unit 53 combines the converted image data P11, P12, P13, and P14 cut out. As a result, the bird's eye image PDa around the excavator 1 is generated. In addition, the display data generation unit 53 adds the symbol image 1S indicating the excavator 1 to the bird's eye image PDa. The symbol image 1S corresponds to an image of the excavator 1 viewed from above. The symbol image 1S clarifies the positional relationship between the excavator 1 and a periphery around the excavator 1.

Note that the bird's eye image PDa is not generated in a frame region E0 in the front and left front of the cab 6. The driver seated on the driver seat 9 can directly visually recognize the conditions in the front and left front of the cab 6. Therefore, the excavator 1 is not provided with the cameras 30 that acquire image data indicating conditions of the front and left front of the cab 6. As a result, the number of cameras 30 provided in the excavator 1 can be reduced. Note that the camera 30 that acquires the image data indicating the conditions of the front and left front of the cab 6 may be provided to generate the bird's eye image PDa in the frame region E0.

[Periphery Monitoring Method]

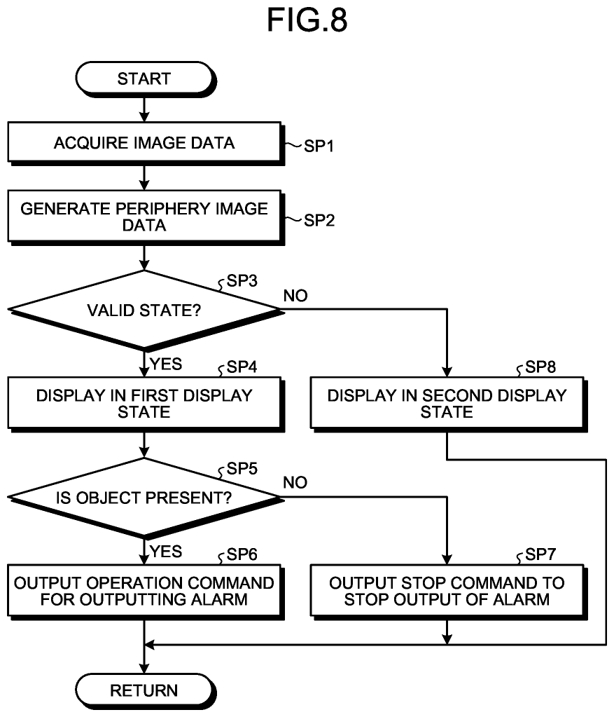

FIG. 8 is a flowchart illustrating a periphery monitoring method according to the embodiment. When the excavator 1 is keyed on, the periphery monitoring device 100 is activated. Immediately after the periphery monitoring device 100 is activated, the periphery monitoring device 100 is set to the valid state in which the alarm is output when the object OB is present around the excavator 1.

The cameras 30 capture images around the excavator 1. The image data acquisition unit 51 acquires the image data from the cameras 30 (Step SP1).

The display data generation unit 53 generates the periphery image data PD. The display data generation unit 53 generates at least the bird's eye image PDa (Step SP2).

The operation command acquisition unit 52 acquires the operation command from the operation unit 22. The operation command determination unit 59 determines whether the operation command acquired by the operation command acquisition unit 52 is an operation command for setting the valid state or an operation command for setting the invalid state. In the present embodiment, the operation command determination unit 59 determines whether or not the operation command acquisition unit 52 has acquired the operation command for switching from the valid state to the invalid state. In other words, the operation command acquisition unit 52 determines whether or not the function of detecting the object OB is in the valid state (Step SP3).

In Step SP3, when it is determined to be in the valid state (Step SP3: Yes), the display control unit 55 causes the display unit 21 to display the bird's eye image PDa and the guide line GD in a first display state (Step SP4).

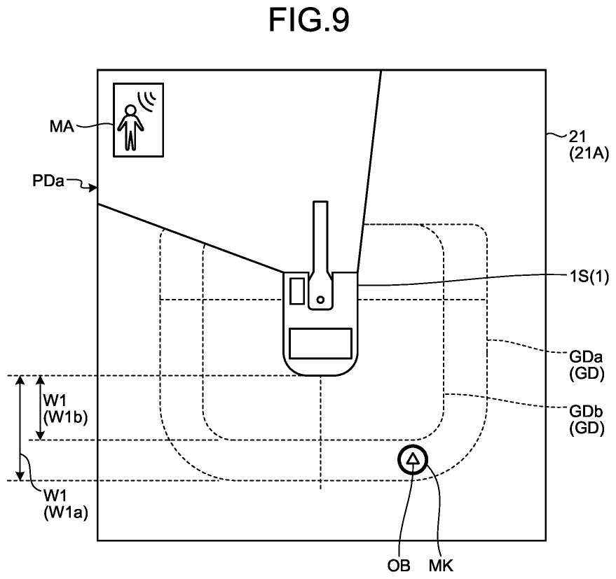

FIG. 9 illustrates a display example of the display unit 21 according to the embodiment. FIG. 9 illustrates the display example of the display unit 21 when the periphery monitoring device 100 is in a valid state.

As illustrated in FIG. 9, the display control unit 55 causes the display unit 21 to display the bird's eye image PDa and the guide line GD arranged in at least a part of the periphery of the symbol image 15 indicating the excavator 1 in the bird's eye image PDa. In the valid state, the display control unit 55 causes the display unit 21 to display the guide line GD in the first display state. Note that the display control unit 55 may display the symbol MA on the display unit 21 in the valid state.

The guide line GD is displayed to include the symbol image 1S. In the embodiment, the guide line GD includes a first guide line GDa defining the first alarm range Ba and a second guide line GDb defining the second alarm range Bb. The symbol image 15 is displayed inside the second guide line GDb. The second guide line GDb is displayed inside the first guide line GDa. An area surrounded by the second guide line GDb is smaller than an area surrounded by the first guide line GDa.

In the embodiment, each of the first guide line GDa and the second guide line GDb has a substantially rectangular shape. A front end of the first guide line GDa and a front end of the second guide line GDb may be displayed so as to coincide with each other. A back end of the first guide line GDa is defined behind a back end of the second guide line GDb. A left end of the first guide line GDa is defined to the left of a left end of the second guide line GDb. A right end of the first guide line GDa is defined to the right of a right end of the second guide line GDb.

As illustrated in FIG. 9, the display control unit 55 causes the display unit 21 to display the guide line GD such that the guide line GD and the symbol image 15 are separated from each other in the valid state. In the example illustrated in FIG. 9, a distance between the outer edge of the symbol image 1S and the guide line GD is a first distance W1. A distance between the back end of the symbol image 1S and the back end of the first guide line GDa is a first distance W1a. A distance between the back end of the symbol image 1S and the back end of the second guide line GDb is a first distance W1b. The outer edge and the back end of the symbol image 1S correspond to the outer edge and the back end of the upper swinging platform 3.

The object determination unit 54 determines whether or not the object OB is present around the excavator 1 based on the image data acquired by the image data acquisition unit 51. In the embodiment, the object determination unit 54 determines whether or not the object OB is present in the alarm range B. In other words, the object determination unit 54 determines whether or not the object OB is present inside the guide line GD (Step SP5).

In Step SP5, when it is determined that the object OB is present in the alarm range B (Step SP5: Yes), the alarm control unit 56 outputs the operation command for outputting the alarm (Step SP6). As the alarm, as illustrated in FIG. 9, the display control unit 55 may cause the display unit 21 to display a marker MK that overlaps the object OB shown in the bird's eye image PDa. The marker MK is an example of a symbol for displaying the object OB present in the alarm range B on the display screen of the display unit 21. In addition, an operation command for performing other alarms such as the buzzer output from the alarm unit 24 or the message displayed on the display unit 21 may be output.

FIG. 9 illustrates a case where the object OB is present inside the first guide line GDa (first alarm range Ba) and outside the second guide line GDb (second alarm range Bb). Also when the object OB is present inside the second guide line GDb (second alarm range Bb) in the valid state, the marker MK that overlaps the object OB shown in the bird's eye image PDa is displayed.

When the object OB is present inside the first guide line GDa (first alarm range Ba) and outside the second guide line GDb (second alarm range Bb), the marker MK is displayed in a first color (for example, yellow). When the object OB is present inside the second guide line GDb (second alarm range Bb), the marker MK is displayed in a second color (for example, red).

When the object OB is present inside the second guide line GDb (second alarm range Bb), the operation of the vehicle body of the work machine 1 may be restricted.

In Step SP5, when it is determined that the object OB is not present in the alarm range B (Step SP5: No), the alarm control unit 56 outputs the stop command to stop the output of the alarm (Step SP7). For example, when the alarm is the marker MK, the display control unit 55 that has received the stop command does not display the marker MK. For example, when the alarm is the buzzer, the alarm unit 24 that has received the stop command stops the buzzer.

In Step SP3, when it is determined to be the invalid state (Step SP3: No), the display control unit 55 causes the display unit 21 to display the bird's eye image PDa and the guide line GD in a second display state (Step SP8).

Note that a flowchart illustrated in FIG. 8 is an example, and not all steps need to be executed in other embodiments. For example, the periphery monitoring device 100 may not execute Step SP5, Step SP6, and Step SP7.

In Step SP3, the operation command determination unit 59 determines whether or not the operation command acquisition unit 52 has acquired the operation command for switching from the valid state to the invalid state. The operation command determination unit 59 may determine whether or not the operation command acquisition unit 52 has acquired the operation command for switching from the invalid state to the valid state. The operation command determination unit 59 determines whether the operation command acquired by the operation command acquisition unit 52 is the operation command for setting the valid state or the operation command for setting the invalid state.

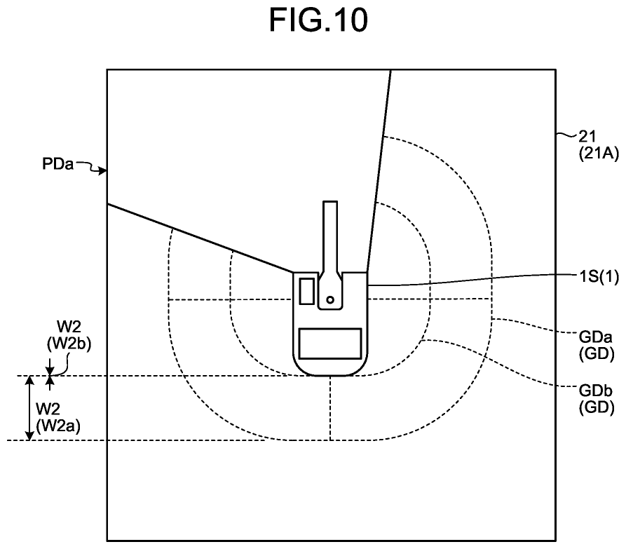

FIG. 10 illustrates a display example of the display unit 21 according to the embodiment. FIG. 10 illustrates the display example of the display unit 21 when the periphery monitoring device 100 is in the invalid state.

As illustrated in FIG. 10, the display control unit 55 causes the display unit 21 to display the bird's eye image PDa and the guide line GD arranged in at least a part of the periphery of the symbol image 1S indicating the excavator 1 in the bird's eye image PDa. In the invalid state, the display control unit 55 causes the display unit 21 to display the guide line GD in the second display state different from the first display state. In addition, the display control unit 55 hides the symbol MA in the invalid state.

The guide line GD in the valid state is different from the guide line GD in the invalid state. As illustrated in FIG. 9 and FIG. 10, the distance between the guide line GD and the excavator 1 (symbol image 1S) in the valid state is different from the distance between the guide line GD and the excavator 1 (symbol image 1S) in the invalid state. The shape of the guide line GD in the valid state is different from the shape of the guide line GD in the invalid state. A size of the area surrounded by the guide line GD in the valid state is different from a size of the area surrounded by the guide line GD in the invalid state.

The guide line GD includes the first guide line GDa and the second guide line GDb. In the invalid state, the outer shape of the first guide line GDa does not match the outer shape of the first alarm range Ba. In the invalid state, the outer shape of the second guide line GDb does not match the outer shape of the second alarm range Bb.

As illustrated in FIG. 10, the display control unit 55 causes the display unit 21 to display the guide line GD such that the guide line GD is closer to the symbol image 1S in the invalid state. In the example illustrated in FIG. 10, the distance between the outer edge of the symbol image 1S and the guide line GD is a second distance W2. The distance between the back end of the symbol image 1S and the back end of the first guide line GDa is a second distance W2a. The second distance W2a may be zero. The distance between the back end of the symbol image 1S and the back end of the second guide line GDb is a second distance W2b. The outer edge and the back end of the symbol image 1S correspond to the outer edge and the back end of the upper swinging platform 3.

The second distance W2 is shorter than the first distance W1. The second distance W2a is shorter than the first distance W1a. The second distance W2b is shorter than the first distance W1b. As described above, the display control unit 55 causes to display the guide line GD such that the distance between the symbol image 1S and the guide line GD becomes the first distance W1 in the valid state, and the distance between the symbol image 1S and the guide line GD becomes the second distance W2 shorter than the first distance W1 in the invalid state. A difference between the first distance W1a and the second distance W2b is shorter than the first distance W1b. A difference between the first distance W1a and the second distance W2b is longer than the second distance W2b. As described above, in the valid state, the display control unit 55 causes to display the guide line GD such that a length relationship of a difference between the first distance W1a and the first distance W1b and the first distance W1b changes.

In the embodiment, the guide line GD in the valid state is displayed outside a swinging range of the upper swinging platform 3. The guide line GD in the invalid state is displayed outside the swinging range of the upper swinging platform 3 and inside the guide line GD in the valid state.

Even in the invalid state, the guide line GD is displayed to include the symbol image 15. The second guide line GDb is displayed to include the symbol image 15. The symbol image 15 is displayed inside the second guide line GDb. The second guide line GDb is displayed inside the first guide line GDa. An area surrounded by the second guide line GDb is smaller than an area surrounded by the first guide line GDa.

In the embodiment, each of the first guide line GDa and the second guide line GDb has a substantially rectangular shape. The front end of the first guide line GDa is defined in front of the front end of the second guide line GDb. A back end of the first guide line GDa is defined behind a back end of the second guide line GDb. A left end of the first guide line GDa is defined to the left of a left end of the second guide line GDb. A right end of the first guide line GDa is defined to the right of a right end of the second guide line GDb.

A size of the area surrounded by the second guide line GDb in the invalid state is smaller than a size of the area surrounded by the second guide line GDb in the valid state.

A size of the area surrounded by the first guide line GDa in the invalid state may be larger or smaller than the size of the area surrounded by the first guide line GDa in the valid state. The size of the area surrounded by the first guide line GDa in the invalid state may be equal to the size of the area surrounded by the first guide line GDa in the valid state.

A size of the symbol image 1S indicating the excavator 1 in the invalid state is equal to the size of the symbol image 1S in the valid state. Note that the sizes of the symbol image 1S in the invalid state and the symbol image 1S in the valid state may be different.

In the invalid state, the driver works while sufficiently recognizing the conditions around the excavator 1. When the driver checks the display unit 21 before operating the working equipment 4, the periphery monitoring device 100 needs to provide the driver with accurate peripheral conditions of the excavator 1. Therefore, the guide line GD is preferably displayed at a position close to the outer edge of the upper swinging platform 3.

In the valid state, when the object OB is present around the excavator 1, the alarm is output even when the driver does not confirm the display unit 21, and thus attention can be attracted. For example, the periphery monitoring device 100 needs to provide the driver with the presence of the object OB in a range sufficiently larger than the swinging range of the upper swinging platform 3. Therefore, the guide line GD is preferably displayed at a position far from the outer edge of the upper swinging platform 3.

[Computer System]

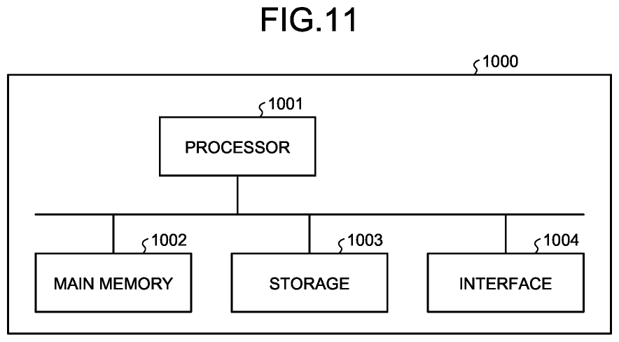

FIG. 11 is a block diagram illustrating a computer system 1000 according to the embodiment. The above-described control unit 23 includes the computer system 1000. The computer system 1000 includes a processor 1001 such as a central processing unit (CPU), a main memory 1002 including a nonvolatile memory such as a read only memory (ROM) and a volatile memory such as a random access memory (RAM), a storage 1003, and an interface 1004 including an input/output circuit. A function of the control unit 23 described above is stored in the storage 1003 as a computer program. The processor 1001 reads the computer program from the storage 1003, develops the computer program in the main memory 1002, and executes the above-described processes according to the computer program. Note that the computer program may be distributed to the computer system 1000 via a network.

According to the aforementioned embodiment, the computer program or the computer system 1000 can cause the display unit 21 to display the image indicating the periphery of the work machine 1, cause the display screen of the display unit 21 to display the guide line in at least a part of the periphery of the work machine 1 together with the image, and switch the display state of the guide line between the valid state in which the alarm is output when the object is present around the work machine 1 and the invalid state in which no alarm is output.

<Effects>

As described above, according to the embodiment, the display control unit 55 switches the display state of the guide line GD between the valid state in which the alarm is output when the object OB is present around the excavator 1 and the invalid state in which no alarm is output. According to the present disclosure, it is possible to provide the appropriate guide line GD to the driver in each of the valid state in which the alarm is output and the invalid state in which no alarm is output.

There is a possibility that a plurality of persons boards the work machine 1. For example, a first driver may board, a second driver different from the first driver may board, or a maintenance person may board. When a first passenger switches the periphery monitoring device to the valid state or the invalid state, it is preferable that a second passenger who gets on the work machine 1 next can easily recognize whether the periphery monitoring device 100 is in the valid state or the invalid state.

In the embodiment, in the invalid state, the guide line GD is displayed on the display unit 21 in the display state different from the valid state. Therefore, the person riding on the work machine 1 can easily recognize whether the periphery monitoring device 100 is in the valid state or the invalid state by checking the guide line GD.

### Other Embodiments

In the aforementioned embodiment, the guide line GD is displayed on the display unit 21 together with the bird's eye image PDa around the work machine 1. The guide line GD may be displayed on the display unit 21 together with the single camera image PDb around the work machine 1. In this case, the display state of the guide line GD is switched according to the operation command output from the operation unit 22. Furthermore, as described with reference to FIG. 5, when both the bird's eye image PDa and the single camera image PDb are displayed on the display unit 21, the guide line GD may be displayed on the display unit 21 together with both the bird's eye image PDa and the single camera image PDb. In this case, the display state of the guide line GD of the bird's eye image PDa and the single camera image PDb may be switched according to the operation command output from the operation unit 22, or the display state of the guide line GD of one of the bird's eye image PDa and the single camera image PDb may be switched. In addition, the guide line GD may be displayed on one of the bird's eye image PDa and the single camera image PDb, and the display state of the guide line GD may be switched according to the operation command output from the operation unit 22.

In the aforementioned embodiment, the object detection unit is the cameras 30. However, the object detection unit is not limited to the cameras 30. The object detection unit may be a radar device or a laser device provided in the excavator 1.

In the aforementioned embodiment, the guide line GD has a linear shape. However, the guide line GD may not have a linear shape. The guide line GD may include, for example, a plurality of dots.

In the aforementioned embodiment, the valid state and the invalid state are switched by operating the switch in the operation unit 22. The operation unit 22 may include a touch sensor provided on the display screen of the display unit 21. In other words, the display unit 21 may include a touch panel having the function of the operation unit 22. The valid state and the invalid state may be switched by operating the touch panel.

In the aforementioned embodiment, the periphery monitor 20 includes the display unit 21, the operation unit 22, the control unit 23, and the alarm unit 24. A part or all of the display unit 21, the operation unit 22, the control unit 23, and the alarm unit 24 may be provided separately. For example, the display unit 21 may be a display unit provided outside the work machine, such as a tablet personal computer. In this case, the display of the valid state and the display of the invalid state may be switched by the operation unit 22 included in the tablet personal computer, or the display of the valid state and the display of the invalid state may be switched by the tablet personal computer receiving an operation command from the operation unit 22 included in the work machine. For example, the operation unit 22 may be provided on a console on the right side in the cab 6. The valid state and the invalid state may be switched by operating the operation unit 22 provided in the console. Note that the operation unit 22 provided outside the periphery monitor 20 may be disposed at another place in the cab 6 or may be provided outside the cab 6. In addition to the operation unit 22 included in the periphery monitor 20, the operation unit 22 described above may be provided.

In the aforementioned embodiment, the alarm unit 24 outputs the buzzer. The alarm unit 24 may be a voice output device. In this case, the alarm may be a voice output from the voice output device. In addition, the alarm unit 24 may be a warning light.

In the aforementioned embodiment, two guide lines GD are displayed, but the number of guide lines GD may be one or three or more.

Furthermore, the aforementioned embodiment describes that the guide line GD is not displayed in a region corresponding to the frame region E0. However, in other embodiments, the guide line GD may be displayed over the entire periphery of the symbol image 1S indicating the excavator 1.

In addition, the aforementioned embodiment describes that one periphery monitoring device 100 is installed in the work machine 1. However, in other embodiments, a part of the configuration of the periphery monitoring device 100 may be arranged in another periphery monitoring device, and may be realized by a periphery monitoring system including two or more periphery monitoring devices. Note that one periphery monitoring device 100 described in the aforementioned embodiment is also an example of the periphery monitoring system.

In addition, although the periphery monitoring device 100 according to the aforementioned embodiment is installed in the work machine 1, a part or all of the configuration of the periphery monitoring device 100 may be installed outside the work machine 1 in other embodiments. For example, in other embodiments, the periphery monitoring device 100 may control the work machine 1 through the remote operation. In this case, the periphery monitoring device 100 causes the display unit disposed in a remote control room to display the screen.

Further, the aforementioned embodiment describes that the distance or shape of the guide line GD is switched between the valid state in which the alarm is output and the invalid state in which the alarm is not output. However, in other embodiments, a line type of the guide line GD, a color of the guide line GD, a thickness of the guide line GD, a blinking display of the guide line GD, or the like may be switched between the valid state in which the alarm is output and the invalid state in which no alarm is output.

In the aforementioned embodiment, the excavator 1 may be a mining excavator used in a mine or the like, or may be an excavator used in a construction site. Further, the present disclosure can be applied to periphery monitoring systems for dump trucks, wheel loaders, and other work machines.

### REFERENCE SIGNS LIST

1 EXCAVATOR (WORK MACHINE)
1S SYMBOL IMAGE
2 LOWER TRAVELING BODY
3 UPPER SWINGING PLATFORM
4 WORKING EQUIPMENT
4A BOOM
4B ARM
4C BUCKET
5 HYDRAULIC CYLINDER
5A BOOM CYLINDER
5B ARM CYLINDER
5C BUCKET CYLINDER
6 CAB
7 POWER CONTAINER
8 COUNTERWEIGHT
9 DRIVER SEAT
10 OPERATION UNIT
11 LEFT WORK LEVER
12 RIGHT WORK LEVER
13 LEFT TRAVEL LEVER
14 RIGHT TRAVEL LEVER
15 LEFT FOOT PEDAL
16 RIGHT FOOT PEDAL
20 PERIPHERY MONITOR
21 DISPLAY UNIT
21A FIRST AREA
21B SECOND AREA
22 OPERATION UNIT
23 CONTROL UNIT
24 ALARM UNIT
30 CAMERA
31 BACK CAMERA
32 RIGHT BACK CAMERA
33 RIGHT FRONT CAMERA
34 LEFT BACK CAMERA
41 ARITHMETIC PROCESSING UNIT
42 STORAGE UNIT
43 INPUT/OUTPUT INTERFACE
51 IMAGE DATA ACQUISITION UNIT
52 OPERATION COMMAND ACQUISITION UNIT
53 DISPLAY DATA GENERATION UNIT
54 OBJECT DETERMINATION UNIT
55 DISPLAY CONTROL UNIT
56 ALARM CONTROL UNIT
57 FEATURE AMOUNT STORAGE UNIT
58 ALARM RANGE STORAGE UNIT
59 OPERATION COMMAND DETERMINATION UNIT
100 PERIPHERY MONITORING DEVICE
300 CAMERA SYSTEM
1000 COMPUTER SYSTEM
1001 PROCESSOR
1002 MAIN MEMORY
1003 STORAGE
1004 INTERFACE
A DETECTION RANGE
AX BOOM ROTATION AXIS
B ALARM RANGE
Ba FIRST ALARM RANGE
Bb SECOND ALARM RANGE
BX ARM ROTATION AXIS
CX BUCKET ROTATION AXIS
RX SWING AXIS
GD GUIDE LINE
GDa FIRST GUIDE LINE
GDb SECOND GUIDE LINE
E0 FRAME REGION
E1 FRAME REGION
E2 FRAME REGION
E3 FRAME REGION
E4 FRAME REGION
F1 FUNCTION SWITCH
F2 FUNCTION SWITCH
F3 FUNCTION SWITCH
F4 FUNCTION SWITCH
F5 FUNCTION SWITCH
F6 FUNCTION SWITCH
I1 ICON
I2 ICON
I3 ICON
I4 ICON
I5 ICON
OB OBJECT
P1 IMAGE DATA
P2 IMAGE DATA
P3 IMAGE DATA
P4 IMAGE DATA
P11 CONVERTED IMAGE DATA
P12 CONVERTED IMAGE DATA
P13 CONVERTED IMAGE DATA
P14 CONVERTED IMAGE DATA
PD PERIPHERY IMAGE DATA
PDa BIRD'S EYE IMAGE
PDb SINGLE CAMERA IMAGE
MA SYMBOL
MK MARKER
NA SYMBOL
SD CONDITION IMAGE DATA
SDa WATER TEMPERATURE GAUGE
SDb OIL TEMPERATURE GAUGE
SDc FUEL LEVEL GAUGE
W1 FIRST DISTANCE
W1a FIRST DISTANCE
W1b FIRST DISTANCE
W2 SECOND DISTANCE
W2a SECOND DISTANCE
W2b SECOND DISTANCE

1. A work machine periphery monitoring system comprising:
a display control unit that causes a display unit to display an image indicating a periphery of a work machine, and a guide line arranged in at least a part of the periphery of the work machine in the image, wherein
the display control unit performs switching of a display state of the guide line between a valid state in which an alarm is output when an object is present around the work machine and an invalid state in which the alarm is not output.

2. The work machine periphery monitoring system according to claim 1, wherein
the image indicating the periphery of the work machine is a bird's eye image of the periphery of the work machine.

3. The work machine periphery monitoring system according to claim 1, wherein
the image indicating the periphery of the work machine is a single camera image indicating the periphery of the work machine.

4. The work machine periphery monitoring system according to claim 1, wherein
the switching of the display state includes switching of a distance between the work machine and the guide line on a display screen of the display unit.

5. The work machine periphery monitoring system according to claim 4, wherein
the display control unit causes to display the guide line such that the distance is a first distance in the valid state, and the distance is a second distance in the invalid state, the second distance being shorter than the first distance.

6. The work machine periphery monitoring system according to claim 5, wherein
the switching of the display state includes switching of a shape of the guide line on the display screen of the display unit.

7. The work machine periphery monitoring system according to claim 1, further comprising:
an alarm range storage unit that stores an alarm range requiring output of the alarm when the object is present in a detection area of an object detection unit that detects the object around the work machine, wherein
the display control unit causes to display the guide line so as to define the alarm range in the valid state.

8. The work machine periphery monitoring system according to claim 1, further comprising:
an operation command acquisition unit that acquires an operation command output from an operation unit; and
an operation command determination unit that determines whether the operation command is an operation command for setting the valid state or an operation command for setting the invalid state, wherein
the valid state and the invalid state are switched according to determination by the operation command determination unit.

9. A work machine equipped with the work machine periphery monitoring system according to claim 1.

10. A work machine periphery monitoring method comprising:
displaying an image indicating a periphery of a work machine on a display unit;
displaying a guide line in at least a part of the periphery of the work machine on a display screen of the display unit; and
switching a display state of the guide line between a valid state in which an alarm is output when an object is present around the work machine and an invalid state in which the alarm is not output.
